(19) United States
(12) Patent Application Publication
(10) Pub. No.: US 2024/0195021 A1
(43) Pub. Date: Jun. 13, 2024

(54) RECHARGEABLE BATTERY MODULE

(71) Applicant: SAMSUNG SDI CO., LTD., Yongin-si (KR)

(72) Inventors: Hyeok LEE, Yongin-si (KR); Young-Hwan KWON, Yongin-si (KR)

(21) Appl. No.: 18/489,743

(22) Filed: Oct. 18, 2023

(30) Foreign Application Priority Data
Dec. 13, 2022 (KR) 10-2022-0174028

(51) Int. Cl. H01M 50/505; H01M 50/242; H01M 50/519; H01M 50/522; H01M 50/536; H01M 50/595

(52) U.S. Cl. CPC H01M 50/505; H01M 50/242; H01M 50/519; H01M 50/522; H01M 50/536; H01M 50/595

(57) ABSTRACT

A rechargeable battery module is provided. The rechargeable battery module may include battery cells aligned in a first direction, a busbar holder configured to cover the battery cells while exposing electrode terminals of the battery cells, a busbar configured to connect the electrode terminals, and a flexible printed circuit connected to the busbar, covered with a film, and including a body portion including signal lines in the film, a sensor coupled to the busbar, a connection portion including a connection line connecting the signal line and the sensor in the film, and having a connection width, and a slot hole passing through the film along a perimeter of the sensor to define the connection portion, and having a penetration width.

### CROSS-REFERENCE TO RELATED APPLICATION

The present application claims priority to and the benefit of Korean Patent Application No. 10-2022-0174028, filed on Dec. 13, 2022, in the Korean Intellectual Property Office, the entire disclosure of which is incorporated herein by reference.

### BACKGROUND

### 1. Field

The present disclosure relates to a rechargeable battery module.

### 2. Description of the Related Art

A rechargeable battery can be repeatedly charged and discharged, unlike a primary battery. Small-capacity rechargeable batteries are used in portable electronic devices, such as mobile phones, notebook computers, and camcorders.

Large-capacity and high-density rechargeable batteries are used for power for motor driving of hybrid vehicles and electric vehicles, or for energy storage. The rechargeable battery may be used by forming a rechargeable battery module including a plurality of battery cells connected in series and/or parallel to drive a motor of, for example, a hybrid vehicle suitably using relatively high energy density.

For example, a rechargeable battery module uses a sensing tab to connect a flexible printed circuit (FPC) for measuring cell voltage and a busbar made of aluminum or copper.

Due to swelling generated in a battery cell, an aluminum busbar connected to an electrode terminal of the battery cell may flow, that is shift or move. Accordingly, a sensor of the flexible printed circuit, and a welding unit of the sensing tab, may be affected. Thus, the flexible printed circuit applies a structure capable of absorbing a flow to the sensor.

However, a total amount of elongation in a rechargeable battery module is within about 3 mm, and the sensor provided to absorb it may be formed to have an excessively large shape or an excessively small shape.

If the sensor is formed to have an excessively large shape, the sensor suitably uses an excessively wide area for flow absorption, and handling in a process may be difficult due to a long length and a flexible material of the sensor. Accordingly, fixing defects and welding defects may occur.

In addition, if the sensor is formed to have an excessively small shape, a length of the sensor for absorbing a flow may be short, but because the flow-absorbing structure is open to the outside, a curling phenomenon occurs during a process of manufacturing an FPC. Accordingly, fixing defects may occur, and welding defects may occur.

### SUMMARY

One or more embodiments of the present disclosure provide a rechargeable battery module capable of protecting a connection portion between a sensor and a busbar in a flexible printed circuit (FPC) from a flow transferred from the busbar.

One or more embodiments of the present disclosure provide a rechargeable battery module capable of protecting a connection portion between a sensor and a sensing tab connected to a busbar in a flexible printed circuit (FPC) from a flow transferred from the busbar.

One or more embodiments provide a rechargeable battery module including battery cells aligned in a first direction, a busbar holder configured to cover the battery cells while exposing electrode terminals of the battery cells, a busbar configured to connect the electrode terminals, and a flexible printed circuit connected to the busbar, covered with a film, and including a body portion including signal lines in the film, a sensor coupled to the busbar, a connection portion including a connection line connecting the signal line and the sensor in the film, and having a connection width, and a slot hole passing through the film along a perimeter of the sensor to define the connection portion, and having a penetration width.

The body portion may have a planar area having a length in the first direction, and a width in a second direction crossing the first direction, wherein the sensor is in the planar area and is connected to the body portion by the connection portion.

The busbar may include aluminum, wherein the sensor includes copper, and wherein a welded portion of the busbar and the sensor includes aluminum and copper.

The welded portion of the busbar and the sensor may be ultrasonic welded, laser welded, or spot welded.

The busbar and the sensor may be bonded by anisotropic conductive film (ACF) bonding, soldering bonding, or mechanical bonding.

The connection line may have a line width in the first direction, wherein the connection portion has a first connection width and a second connection width respectively between opposite sides of the connection line and opposite ends of the slot hole in the first direction.

The opposite ends of the slot hole may be round and have a diameter that is equal to the penetration width.

The slot hole may have a distance from an end of the sensor in the first direction toward the connection line, the distance being equal to, or greater than, a flow amount of an entirety of the rechargeable battery module.

A distance of the slot hole may be greater than a sum of swelling amounts of the battery cells.

The first connection width and the second connection width may be greater than the line width.

The opposite ends of the slot hole may have a round shape having a diameter that is greater than the penetration width toward the connection line.

An inner side of the slot hole that is adjacent one of the opposite ends having the round shape may extend in the first direction, wherein an outer side of the slot hole that is adjacent the one of the opposite ends having the round shape extends at an angle with respect to the first direction.

The diameter of the opposite ends of the slot hole may be greater than a flow amount of an entirety of the rechargeable battery module.

The sensor may include a welded portion welded to the busbar, a notch portion on at least one side of the welded portion, and an adhesive portion in the notch portion.

The rechargeable battery module may further include an adhesive or a tape attaching the busbar to the flexible printed circuit.

The adhesive or the tape may attach the busbar and the film, which covers the sensor inside the slot hole.

The rechargeable battery module may further include a sensing tab connecting the sensor of the flexible printed circuit to the busbar.

The sensing tab may include a first connection portion above the slot hole, and connected to the sensor, and a second connection portion connected to the busbar.

The rechargeable battery module according to one or more embodiments includes a body portion, a sensor, a slot hole, and a connection portion in a flexible printed circuit. The sensor is connected to the busbar, and the flow transferred from the busbar may be absorbed in the slot hole, and thus, the connection portion between the sensor and the busbar may be protected from the flow.

### BRIEF DESCRIPTION OF THE DRAWINGS

FIG. 1 illustrates an exploded perspective view of a rechargeable battery module according to one or more embodiments of the present disclosure.

FIG. 2 illustrates a partial perspective view of FIG. 1.

FIG. 3 illustrates a top plan view showing a flexible printed circuit and a sensor applied to FIG. 2.

FIG. 4 illustrates a top plan view showing a state in which a flexible printed circuit and a sensor are positioned on a busbar.

FIG. 5 illustrates a cross-sectional view taken along the line V-V of FIG. 4.

FIG. 6 illustrates a top plan view showing a flexible printed circuit and a sensor applied to a rechargeable battery module according to one or more other embodiments of the present disclosure.

FIG. 7 illustrates a top plan view showing a flexible printed circuit and a sensor applied to a rechargeable battery module according to one or more additional embodiments of the present disclosure.

FIG. 8 illustrates a cross-sectional view taken along the line VI-VII of FIG. 7.

FIG. 9 illustrates a top plan view showing a flexible printed circuit and a sensor applied to a rechargeable battery module according to one or more further embodiments of the present disclosure.

FIG. 10 illustrates a cross-sectional view taken along the line X-X of FIG. 9.

FIG. 11 illustrates a top plan view showing a flexible printed circuit applied to a rechargeable battery module and a sensor according to yet one or more other embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The present disclosure covers all modifications, equivalents, and replacements within the idea and technical scope of the present disclosure. Further, each of the features of the various embodiments of the present disclosure may be combined or combined with each other, in part or in whole, and technically various interlocking and driving are possible. Each embodiment may be implemented independently of each other or may be implemented together in an association.

In the drawings, the relative sizes of elements, layers, and regions may be exaggerated for clarity and/or descriptive purposes. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or intervening layers, regions, or components may be present. However, “directly connected/directly coupled,” or “directly on,” refers to one component directly connecting or coupling another component, or being on another component, without an intermediate component. In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expression such as “at least one of A and B” and “at least one of A or B” may include A, B, or A and B. As used herein, “or” generally means “and/or,” and the term “and/or” includes any and all combinations of one or more of the associated listed items. For example, the expression such as “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

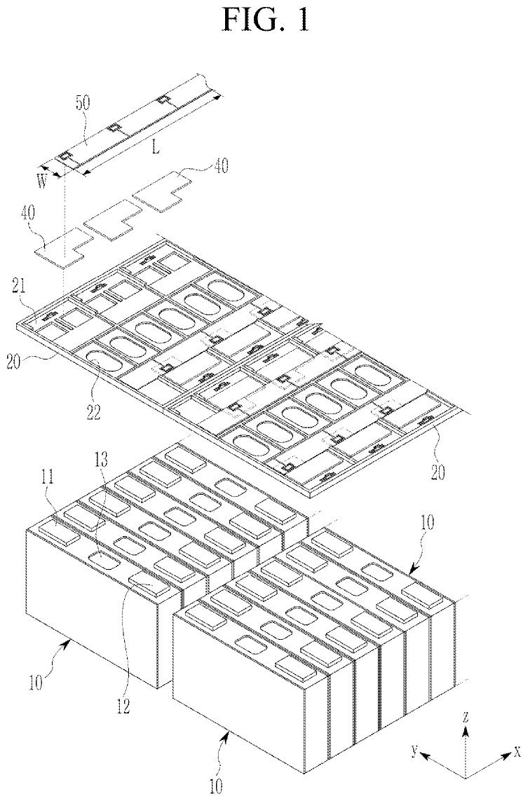

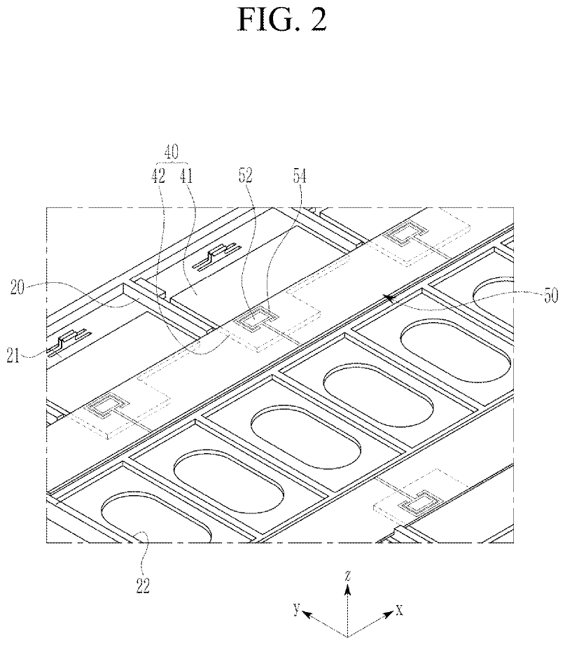

FIG. 1 illustrates an exploded perspective view of a rechargeable battery module according to one or more embodiments of the present disclosure, and FIG. 2 illustrates a partial perspective view of FIG. 1.

Referring to FIG. 1 and FIG. 2, the rechargeable battery module according to one or more embodiments includes a plurality of battery cells 10, a busbar holder 20, a busbar(s) 40, and a flexible printed circuit (FPC) 50.

The rechargeable battery module according to one or more embodiments may include module frames of various structures, but a detailed description of this configuration may be omitted, and the configuration including a main part of the present disclosure will be mainly described.

The battery cells 10 are formed as rechargeable batteries, and are stacked or aligned in a first direction (e.g., in an x-axis direction). A pair of end plates are respectively located at opposite ends of the stacked battery cells 10 in the first direction to set restraints of the battery cells 10 in the first direction/x-axis direction.

A pair of side plates are located at opposite sides of the battery cells 10 in a second direction (e.g., in a y-axis direction) crossing the first direction to be connected to the pair of end plates to set restraints of the battery cells 10 in the second direction.

As in the one or more embodiments corresponding to FIG. 1, if the battery cells 10 are arranged in two rows, a center plate may be positioned between the pair of side plates (e.g., between adjacent side plates of respective rows of battery cells 10). The center plate is positioned between the two rows of battery cells 10, and extending in the first direction, to set second direction restraints of the battery cells 10 at opposite sides.

The busbar holder 20 includes a busbar support 21 for electrical connection, and for insulation of electrode terminals 11 and 12 of the battery cells 10; and a vent 22 for discharging vent gas from battery cells 10.

The busbar support 21 covers the battery cells 10 while exposing the electrode terminals 11 and 12 in a third direction (cell height, z-axis direction). The third direction (cell height, z-axis direction) intersects the first direction (cell thickness, x-axis direction) and the second direction (cell length, y-axis direction).

The busbar 40 is welded to the electrode terminals 11 and 12 exposed in the third direction through the busbar support 21 to electrically and mechanically connect respective ones of the electrode terminals 11 and 12. That is, the busbar 40 connects respective electrode terminals 11 and 12 of respective battery cells 10 that are adjacent to each other in the first direction in parallel or in series.

The vent 22 of the busbar holder 20 is configured to correspond to the vents 13 of the battery cells 10 to discharge an opening pressure of the battery cell 10, and to discharge ejected material to an outside of the busbar holder 20 if the vents 13 are opened.

Busbar supports 21 corresponding to the electrode terminals 11 and 12 in the second direction (cell length, y-axis direction) are positioned at opposite sides, and as such, the vent 22, which corresponds to the vents 13 provided between the electrode terminals 11 and 12, is located between portions of the busbar support 21.

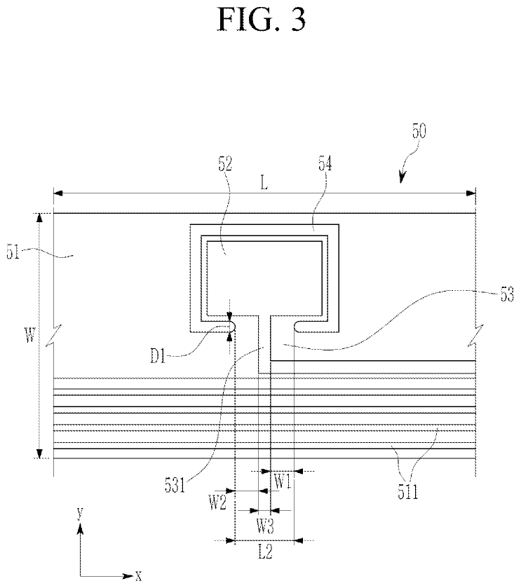

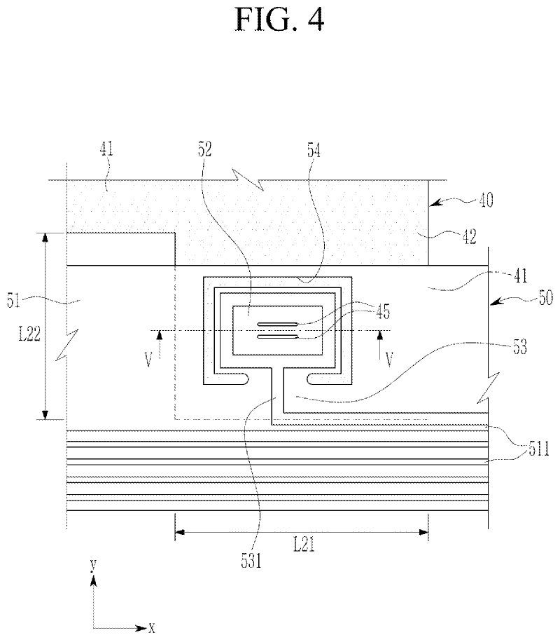

FIG. 3 illustrates a top plan view showing a flexible printed circuit and a sensor applied to FIG. 2, and FIG. 4 illustrates a top plan view showing a state in which a flexible printed circuit and a sensor are positioned on a busbar.

Referring to FIG. 1 to FIG. 4, the busbar 40 includes a first corresponding portion 41 connected to correspond to the electrode terminals 11 and 12, and a second corresponding portion 42 connected to correspond to the flexible printed circuit 50.

The flexible printed circuit 50 is connected to the busbar 40, and is covered with two films 501 and 502. For example, the flexible printed circuit 50 forms a printed circuit at an inner portion on which two films 501 and 502 are attached in the thickness direction, and includes a body portion 51, a sensor 52, a connection portion 53, and a slot hole 54.

The body portion 51 includes a plurality of signal lines 511 formed as a printed circuit in the films 501 and 502. For example, in the flexible printed circuit 50, the films 501 and 502 may be formed of a polyimide film or a polyester film.

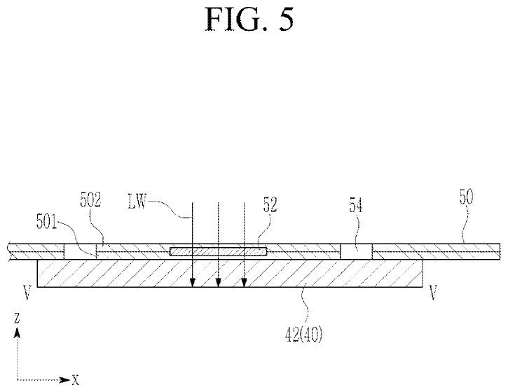

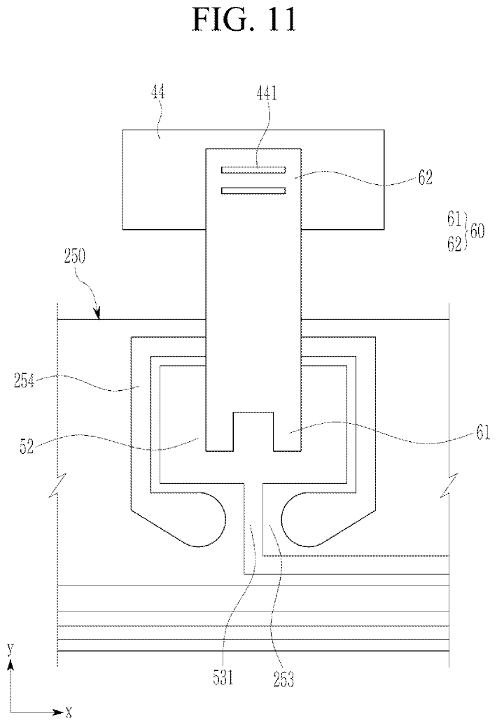

FIG. 5 illustrates a cross-sectional view taken along the line V-V of FIG. 4. Referring to FIG. 2 to FIG. 5, the sensor 52 is connected to a side of the busbar 40, is formed of a thin copper film, and is open to one side or to opposite sides. Accordingly, the sensor 52 may be directly connected to the busbar 40. In addition, the sensor 52 may be indirectly connected to the busbar 40 (see FIG. 11).

The connection portion 53 forms a connection line 531 connecting the signal line 511 and the sensor 52 in the films 501 and 502, and has a total connection width (W1+W2+W3, as shown in FIG. 3) set by the films 501 and 502.

The slot hole 54 penetrates the films 501 and 502 along a circumference, or perimeter, of the sensor 52 to form the connection portion 53, and has a penetration width (e.g., predetermined penetration width). That is, the slot hole 54 is formed to pass through the films 501 and 502, and the connection portion 53 is formed to not pass through the films 501 and 502.

Again, in the flexible printed circuit 50, the body portion 51 has a planar area L*W set to a length L in the first direction/x-axis direction and a width W in the second direction/y-axis direction (e.g., see FIG. 3). The sensor 52 is formed in a plurality along the first direction in the planar area L*W while closing the planar area L*W of the body portion 51, and is connected to the body portion 51 through each connection portion 53.

The connection line 531 has a line width W3 that is set in the first direction/x-axis direction. The connection portion 53 has a first connection width W1 and a second connection width W2 that are set between opposite sides of the connection line 531 and ends of the slot hole 54 in the first direction, respectively. The first connection width W1 and the second connection width W2 of the connection portion 53 protect the connection line 531 to maintain connection between the sensor 52 and the signal line 511.

Opposite ends of the slot hole 54 are formed in a round shape (e.g., semicircular) having a diameter D1 that is equal to a penetration width toward the connection line 531. The round shape reduces or prevents the likelihood of breakage due to stress concentration at an end of the slot hole 54. In addition, the slot hole 54 has a distance L2 set from an end of the sensor 52 in the first direction toward the connection line 531.

This distance L2 is set equal to, or greater than, a flow amount (that is, movement amount) of the entire module. That is, the distance L2 of the slot hole 54 is set to be greater than a sum of swelling amounts for each of the battery cells 10. This distance L2 may be set to the total connection width (W1+W2+W3) to make it possible to stably maintain a connection structure or welding structure of the sensor 52 and the busbar 40 while effectively responding to the flow amount of the entire module along the first direction.

In addition, the first connection width W1 and the second connection width W2 are set to be greater than the line width W3, and thus it is possible to reduce or prevent the likelihood of cutting the connection line 531 with respect to the flow amount of the entire module along the first direction.

Although integrity of the sensor 52 and the signal line 511 may be weakened due to the slot hole 54, the distance L2 of the connection portion 53 may maintain the strength of the connection line 531, and may also allow the slot hole 54 to sufficiently absorb a flow transferred to the battery cell 10 and the busbar 40.

Referring to FIG. 1, FIG. 2, FIG. 4, and FIG. 5, the busbar 40 is made of aluminum, and the sensor 52 is made of copper. The busbar 40 and the sensor 52 may be connected by ultrasonic welding, laser welding (LW), or spot welding.

In the busbar 40, the first corresponding portion 41 is connected to the electrode terminals 11 and 12 by welding, and the second corresponding portion 42 may be connected to the flexible printed circuit 50 by welding. The second corresponding portion 42 protrudes from one side of the first corresponding portion 41 in the second direction/y-axis direction to be connected to the sensor 52 of the flexible printed circuit 50 by welding. By the action of welding, a welded portion 45 connecting the second corresponding portion 42 and the sensor 52 is formed.

In addition, the second corresponding portion 42 has an area L21*L22 of a first length L21 in the first direction/x-axis direction, and a second length L22 in the second direction/y-axis direction. The second corresponding portion 42 supports the sensor 52, the connection portion 53, the slot hole 54, the connection line 531, and the signal line 511 of the flexible printed circuit 50. The connection line 531 may be entirely supported, and the signal line 511 may be partially supported.

As such, the rechargeable battery module of the one or more embodiments corresponding to FIG. 1 may stabilize a connection structure of the busbar 40 and the sensor 52 with respect to the flow amount of the entire module, and may reduce or prevent the likelihood of the connection line 531 being cut.

In addition, the rechargeable battery module of the one or more embodiments corresponding to FIG. 1 supports a large area of the flexible printed circuit 50 with the second corresponding portion 42 of the busbar 40, and it may protect the flexible printed circuit 50 from a flow transferred from the busbar 40 while reducing or preventing sagging of the flexible printed circuit 50.

Meanwhile, in the rechargeable battery module of the one or more embodiments corresponding to FIG. 1, the connection line 531 connects the sensor 52 to the signal line 511. The sensor 52 is connected to the second corresponding portion 42 of the busbar 40 to sense the battery cell 10 connected to the busbar 40, and to transmit a detection signal to the connection line 531 and the signal line 511.

In addition, the connection portion 53 and the slot hole 54 reduce or prevent the likelihood of the flexible printed circuit 50 opening to the outside, to reduce or prevent curling in a manufacturing process of the flexible printed circuit 50, and thus they enable the sensor 52 to be stably fixed to the busbar 40. Accordingly, welding defects due to poor fixation of the sensor 52 may be improved.

Hereinafter, various embodiments of the present disclosure will be described. Compared to the one or more embodiments corresponding to FIG. 1 and the previously described embodiments, descriptions of the same components will be omitted, and descriptions of different components will be described.

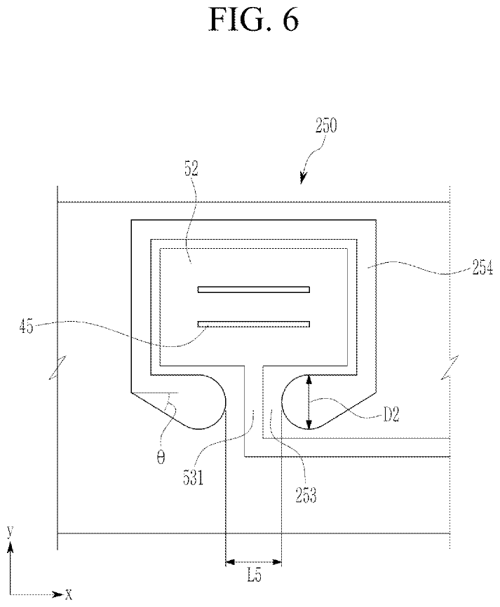

FIG. 6 illustrates a top plan view showing a flexible printed circuit and a sensor applied to a rechargeable battery module according to one or more other embodiments of the present disclosure. Referring to FIG. 6, in the flexible printed circuit 250 applied to the rechargeable battery module of the one or more other embodiments corresponding to FIG. 6, opposite ends of the slot hole 254 are rounded toward the connection line 531 to have a larger diameter D2 than the penetration width. Accordingly, the slot hole 254 has a distance L5 set from an end of the sensor 52 in the first direction toward the connection line 531.

This distance L5 is set equal to or greater than a flow amount of the entire module. That is, the distance L5 of the slot hole 254 is set to be greater than a sum of swelling amounts for each of the battery cells 10. This distance L5 is set to the entire connection width of the connection portion 253 may effectively respond to a flow amount of the entire module along the first direction.

In the meantime, an inside of the round portion at opposite ends of the slot hole 254, that is, a side adjacent to the sensor 52, is connected to the slot hole 254 in the first direction/x-axis direction, and an outer side of the round portion, that is, a far side from the sensor 52, is connected to the slot hole 254 at an angle θ with respect to the first direction/x-axis direction.

Compared to the slot hole 54 of the one or more embodiments corresponding to FIG. 1, the outer side of the round shape connected at an angle θ in the slot hole 254 may more effectively respond to the amount of flow of the entire module along the first direction, and makes it possible to partially respond even to the flow amount of the entire module along the second direction.

If the distance L5 of the one or more other embodiments corresponding to FIG. 6, and the distance L2 of the one or more embodiments corresponding to FIG. 1, are the same, as compared to the round shape with a diameter D1 being equal to the penetration width in the one or more embodiments corresponding to FIG. 1, the round shape having a diameter D2 that is larger than the penetration width in the one or more other embodiments corresponding to FIG. 6 may more effectively disperse a stress caused by the flow, thereby making it possible to respond more effectively to the flow amount of the entire module.

That is, the likelihood of breakage of the connection portion 253 of the one or more other embodiments corresponding to FIG. 6, which stably maintains the connection structure or welding structure between the sensor 52 and the busbar 40, may be reduced or prevented more effectively than the connection portion 53 of the one or more embodiments corresponding to FIG. 1 for stably maintaining the connection structure or welding structure between the sensor 52 and the busbar 40.

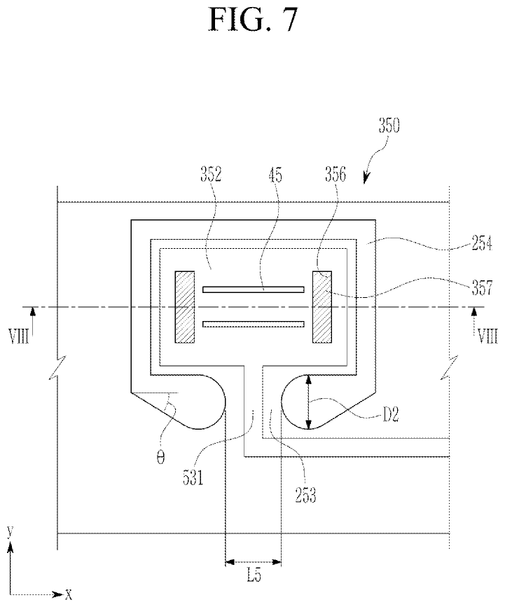

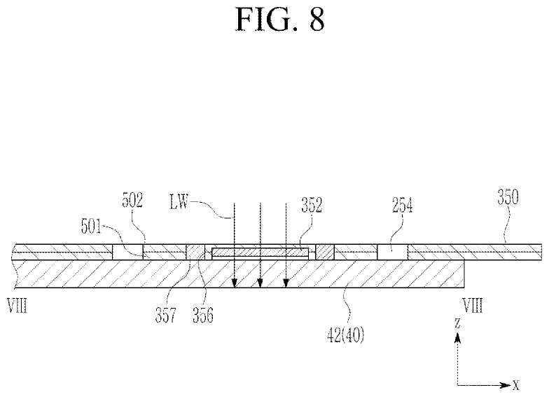

FIG. 7 illustrates a top plan view showing a flexible printed circuit and a sensor applied to a rechargeable battery module according to one or more additional embodiments of the present disclosure, and FIG. 8 illustrates a cross-sectional view taken along the line VIII-VIII of FIG. 7.

Referring to FIG. 7 and FIG. 8, in the flexible printed circuit 350 applied to the rechargeable battery module of the one or more additional embodiments corresponding to FIGS. 7 and 8, the sensor 352 includes a welded portion 45, a notch portion 356, and an adhesive portion 357.

The notch portion 356 is formed on at least one side of the welded portion 45. That is, the notch portion 356 is formed to extend through the sensor 352 and the two films 501 and 502 provided at opposite sides of the sensor 352. The adhesive portion 357 injects adhesive into the notch portion 356 to further strengthen adherence between the sensor 352 and the films 501 and 502.

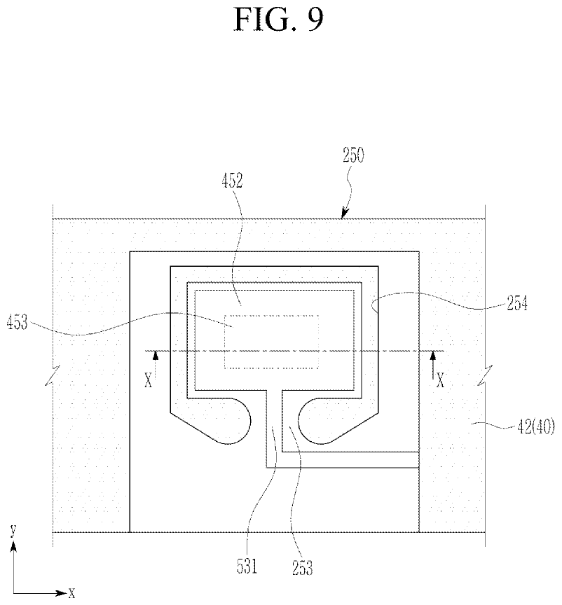

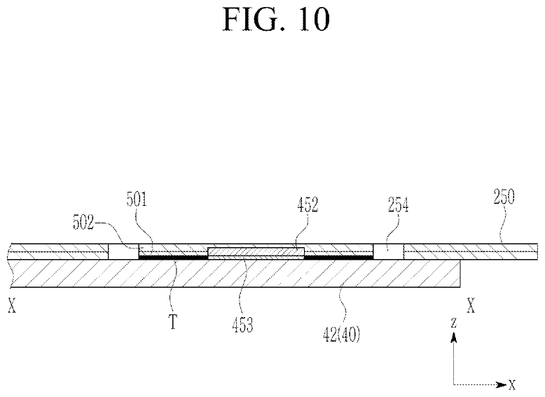

FIG. 9 illustrates a top plan view showing a flexible printed circuit and a sensor applied to a rechargeable battery module according to one or more further embodiments of the present disclosure, and FIG. 10 illustrates a cross-sectional view taken along the line X-X of FIG. 9.

Referring to FIG. 9 and FIG. 10, the busbar 40 and the flexible printed circuit 250 applied to the rechargeable battery module of the one or more further embodiments corresponding to FIGS. 9 and 10 may be bonded to each other.

As an example, the second corresponding portion 42 of the busbar 40 and the sensor 452 are formed by using a type of bonding 453, such as anisotropic conductive film (ACF) bonding, soldering bonding, and mechanical bonding. FIG. 10 illustrates an anisotropic conductive film as an example of the bonding 453.

In addition, the second corresponding portion 42 of the busbar 40 and the sensor 452 of the flexible printed circuit 250 may be attached with an adhesive or a tape T. That is, the tape T is attached to a side of the film 501 covering the sensor 452, and to the second corresponding portion 42 inside or adjacent to the slot hole 254. Attachment of the tape T further strengthens the bonding 453 between the sensor 452 and the second corresponding portion 42.

FIG. 11 illustrates a top plan view showing a flexible printed circuit applied to a rechargeable battery module and a sensor according to yet one or more other embodiments of the present disclosure. Referring to FIG. 11, in the rechargeable battery module according to the one or more embodiments corresponding to FIG. 11, the sensor 52 of the flexible printed circuit 250 is connected to the busbar 44 through a sensing tab 60. The sensing tab 60 includes a first connection portion 61 and a second connection portion 62.

The first connection portion 61 is positioned above the slot hole 254 to be connected to the sensor 52. The connection between the first connection portion 61 and the sensor 52 may be formed by applying the structure of the welded portion 45 of the one or more embodiments corresponding to FIG. 1, and the bonding 453 of the one or more embodiments corresponding to FIGS. 9 and 10. The second connection portion 62 is connected to the busbar 44 by welding 441. The sensing tab 60 may reduce or prevent sagging of the flexible printed circuit 250.

Accordingly, the embodiments of the present disclosure may provide a rechargeable battery module connecting a sensor of a flexible printed circuit (FPC) to a busbar.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims, with functional equivalents thereof to be included therein.

Description of Some of the Reference Characters

| | |
|---|---|
| 10: battery cell | 11, 12: electrode terminal |
| 13: vent | 20: busbar holder |
| 21: busbar support | 22: vent |
| 40, 44: busbar | 41: first corresponding portion |
| 42: second corresponding portion | 44: busbar |
| 45: welded portion | 50: flexible printing circuit (FPC) |
| 51: body portion | 52: sensor |
| 53: connection portion | 54: slot hole |
| 60: sensing tab | 61: first connection portion |
| 62: second connection portion | 254: slot hole |
| 350: flexible printing circuit | 352: sensor |
| 356: notch portion | 357: adhesive portion |
| 452: sensor | 453: bonding |
| 501, 502: film | 511: signal line |
| 531: connection line | D1: diameter |
| D2: diameter | L: length |
| L2: distance | L5: distance |
| LW: laser welding | L*W: planar area |
| L21: first length | L22: second length |
| L21*L22: area | T: tape |
| W: width | W1: first connection width |
| W2: second connection width | W1 + W2 + W3: entire connection |
| | width |
| W3: line width | θ: angle |

What is claimed is:

1. A rechargeable battery module comprising:
battery cells aligned in a first direction;
a busbar holder configured to cover the battery cells while exposing electrode terminals of the battery cells;
a busbar configured to connect the electrode terminals; and
a flexible printed circuit connected to the busbar, covered with a film, and comprising:
a body portion comprising signal lines in the film;
a sensor coupled to the busbar;
a connection portion comprising a connection line connecting the signal line and the sensor in the film, and having a connection width; and
a slot hole passing through the film along a perimeter of the sensor to define the connection portion, and having a penetration width.

2. The rechargeable battery module as claimed in claim 1, wherein the body portion has a planar area having a length in the first direction, and a width in a second direction crossing the first direction, and
wherein the sensor is in the planar area and is connected to the body portion by the connection portion.

3. The rechargeable battery module as claimed in claim 1, wherein the busbar comprises aluminum,
wherein the sensor comprises copper, and
wherein a welded portion of the busbar and the sensor comprises aluminum and copper.

4. The rechargeable battery module as claimed in claim 3, wherein the welded portion of the busbar and the sensor is ultrasonic welded, laser welded, or spot welded.

5. The rechargeable battery module as claimed in claim 1, wherein the busbar and the sensor are bonded by anisotropic conductive film (ACF) bonding, soldering bonding, or mechanical bonding.

6. The rechargeable battery module as claimed in claim 1, wherein the connection line has a line width in the first direction, and
wherein the connection portion has a first connection width and a second connection width respectively between opposite sides of the connection line and opposite ends of the slot hole in the first direction.

7. The rechargeable battery module as claimed in claim 6, wherein the opposite ends of the slot hole are round and have a diameter that is equal to the penetration width.

8. The rechargeable battery module as claimed in claim 6, wherein the slot hole has a distance from an end of the sensor in the first direction toward the connection line, the distance being equal to, or greater than, a flow amount of an entirety of the rechargeable battery module.

9. The rechargeable battery module as claimed in claim 6, wherein a distance of the slot hole is greater than a sum of swelling amounts of the battery cells.

10. The rechargeable battery module as claimed in claim 6, wherein the first connection width and the second connection width are greater than the line width.

11. The rechargeable battery module as claimed in claim 6, wherein the opposite ends of the slot hole have a round shape having a diameter that is greater than the penetration width toward the connection line.

12. The rechargeable battery module as claimed in claim 11, wherein an inner side of the slot hole that is adjacent one of the opposite ends having the round shape extends in the first direction, and
wherein an outer side of the slot hole that is adjacent the one of the opposite ends having the round shape extends at an angle with respect to the first direction.

13. The rechargeable battery module as claimed in claim 11, wherein the diameter of the opposite ends of the slot hole is greater than a flow amount of an entirety of the rechargeable battery module.

14. The rechargeable battery module as claimed in claim 11, wherein the sensor comprises:
a welded portion welded to the busbar;
a notch portion on at least one side of the welded portion; and
an adhesive portion in the notch portion.

15. The rechargeable battery module as claimed in claim 11, further comprising an adhesive or a tape attaching the busbar to the flexible printed circuit.

16. The rechargeable battery module as claimed in claim 15, wherein the adhesive or the tape attaches the busbar and the film, which covers the sensor inside the slot hole.

17. The rechargeable battery module as claimed in claim 1, further comprising a sensing tab connecting the sensor of the flexible printed circuit to the busbar.

18. The rechargeable battery module as claimed in claim 17, wherein the sensing tab comprises:
a first connection portion above the slot hole, and connected to the sensor; and
a second connection portion connected to the busbar.
